(19) United States
(12) Patent Application Publication
(10) Pub. No.: US 2026/0177693 A1
(43) Pub. Date: Jun. 25, 2026

(54) ULTRASOUND SENSOR CASE AND ULTRASOUND SENSOR APPARATUS

(71) Applicant: Panasonic Automotive Systems Co., Ltd., Kanagawa (JP)

(72) Inventor: Nakayuki KITAOKA, Kanagawa (JP)

(73) Assignee: Panasonic Automotive Systems Co., Ltd., Kanagawa (JP)

(21) Appl. No.: 19/430,964

(22) Filed: Dec. 23, 2025

(30) Foreign Application Priority Data
Dec. 24, 2024 (JP) 2024-227595

(51) Int. Cl. G01S 15/08; G01S 7/521

(52) U.S. Cl. CPC G01S 15/08; G01S 7/521

(57) ABSTRACT

Provided are an ultrasound sensor case and an ultrasound sensor apparatus each capable of reducing performance deterioration caused by side wall vibration. The ultrasound sensor apparatus includes a bottom portion; and a side wall connected to the bottom portion, wherein, the side wall is formed with a non-penetrating inner wall groove on an inner wall surface of the side wall and a non-penetrating outer wall groove on an outer wall surface of the side wall, the non-penetrating inner wall groove not penetrating to the outer wall surface, and the non-penetrating outer wall groove not penetrating to the inner wall surface.. The ultrasound sensor case and the ultrasound sensor apparatus can reduce performance deterioration caused by the side wall vibration while maintaining performance such as directivity, strength, and waterproofness.

### DESCRIPTION

### Technical Field

The present disclosure relates to an ultrasound sensor case and an ultrasound sensor apparatus.

### Background Art

An ultrasound sensor apparatus (hereinafter, referred to as an ultrasound sensor apparatus, an ultrasound sensor, a sensor apparatus, a sensor, or an apparatus) of the related art detects an object by, for example, generating an ultrasonic wave using a piezoelectric element and receiving a reflected wave from the object. The position of the object and the distance to the object can be detected by using a plurality of ultrasound sensors. For example, for the ultrasound sensor of the related art, the shape of an ultrasound sensor case (hereinafter, referred to as an ultrasound sensor case, a sensor case, or a case) is designed in consideration of acoustic characteristics such as an angle range (for example, including directivity) in which an object can be detected. In addition, for the ultrasound sensor of the related art, a metal case including a vibration plate is used, and the shape and material of the case are carefully designed to satisfy characteristics such as mechanical strength and a waterproof structure.

### Citation List

### Patent Literature

PTL 1

Japanese Patent Application Laid-Open No. 2001-169392

### SUMMARY OF INVENTION

In the ultrasound sensor apparatus of the related art, a vertical vibration in a direction perpendicular to a bottom surface of the case and a side wall vibration in a direction perpendicular to a side wall of the case are generated by vibration of the piezoelectric element installed in the case, but studies have not been fully conducted on performance deterioration of the ultrasound sensor apparatus caused by the side wall vibration.

The present disclosure facilitates providing an ultrasound sensor case and an ultrasound sensor apparatus each capable of reducing performance deterioration caused by the side wall vibration.

An ultrasound sensor case according to an embodiment of the present disclosure includes: a bottom portion; and a side wall connected to the bottom portion, wherein, the side wall is formed with a non-penetrating inner wall groove on an inner wall surface of the side wall and a non-penetrating outer wall groove on an outer wall surface of the side wall, the non-penetrating inner wall groove not penetrating to the outer wall surface, and the non-penetrating outer wall groove not penetrating to the inner wall surface.

According to an embodiment of the present disclosure, the ultrasound sensor case and the ultrasound sensor apparatus achieve an effect of reducing performance deterioration caused by the side wall vibration while maintaining performance such as directivity, strength, and waterproofness.

### BRIEF DESCRIPTION OF DRAWINGS

FIG. 1A is a perspective view of an ultrasound sensor case according to an embodiment;

FIG. 1B is a side view of the ultrasound sensor case according to the embodiment;

FIG. 1C is a cross-sectional view of the ultrasound sensor case according to the embodiment;

FIG. 1D is an enlarged cross-sectional view of the ultrasound sensor case according to the embodiment;

FIG. 1E is a side view for describing a length of a non-penetrating groove;

FIG. 1F is a cross-sectional view taken along a line A-A' of FIG. 1E;

FIG. 1G is a cross-sectional view taken along a line B-B' of FIG. 1E;

FIG. 2A is a cross-sectional view of the ultrasound sensor case on which a rubber and a piezoelectric element are mounted according to Comparative Example 1;

FIG. 2B is a side view of the ultrasound sensor case on which the rubber and the piezoelectric element are mounted according to Comparative Example 2;

FIG. 2C is a cross-sectional view of the ultrasound sensor case on which the rubber and the piezoelectric element are mounted according to the embodiment;

FIG. 3 is a side view of the ultrasound sensor case according to Variation 1 of the embodiment;

FIG. 4A is a cross-sectional view of the ultrasound sensor case according to Variation 2A of the embodiment;

FIG. 4B is a cross-sectional view of the ultrasound sensor case according to Variation 2B of the embodiment;

FIG. 5 is a simulation result showing a relationship between a distance in a height direction and a maximum amplitude according to Variation 3 of the embodiment;

FIG. 6 is a planar cross-sectional view of the ultrasound sensor case according to Variation 4 of the embodiment;

FIG. 7A is a plan view illustrating an effective vibration region of the ultrasound sensor case according to Variation 5 of the embodiment;

FIG. 7B is a plan view illustrating another effective vibration region of the ultrasound sensor case according to Variation 5 of the embodiment;

FIG. 8A is a cross-sectional view of the ultrasound sensor case according to Variation 6 of the embodiment;

FIG. 8B is a cross-sectional view of the ultrasound sensor case according to Variation 6, cut along a line A-A' of FIG. 8A;

FIG. 8C is a cross-sectional view of the ultrasound sensor case according to Variation 6, cut along a line B-B' of FIG. 8A;

FIG. 9A is a cross-sectional view of the ultrasound sensor case according to Variation 7A of the embodiment;

FIG. 9B is a cross-sectional view of the ultrasound sensor case according to Variation 7B of the embodiment;

FIG. 9C is an enlarged cross-sectional view of the ultrasound sensor case according to Variation 7B of the embodiment;

FIG. 10A is a planar cross-sectional view of the ultrasound sensor case according to Variation 8A of the embodiment;

FIG. 10B is a planar cross-sectional view of the ultrasound sensor case according to Variation 8B of the embodiment;

FIG. 11 is a cross-sectional view of the ultrasound sensor case according to Variation 9 of the embodiment;

FIG. 12A is a cross-sectional view of the ultrasound sensor case according to Variation 10A of the embodiment;

FIG. 12B is a cross-sectional view of the ultrasound sensor case according to Variation 10B of the embodiment;

FIG. 13A is a cross-sectional view of the ultrasound sensor case according to Variation 11A of the embodiment; and

FIG. 13B is a cross-sectional view of the ultrasound sensor case according to Variation 11B of the embodiment.

### DESCRIPTION OF EMBODIMENTS

Hereinafter, an ultrasound sensor case and an ultrasound sensor apparatus according to an embodiment will be described in detail with reference to the drawings. Note that the same reference signs are assigned to the same components.

### Embodiment

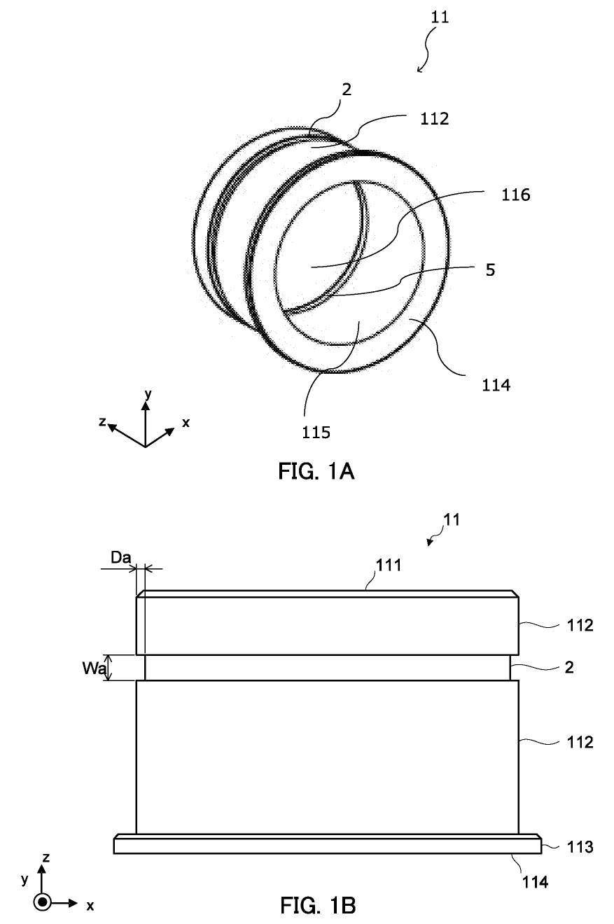

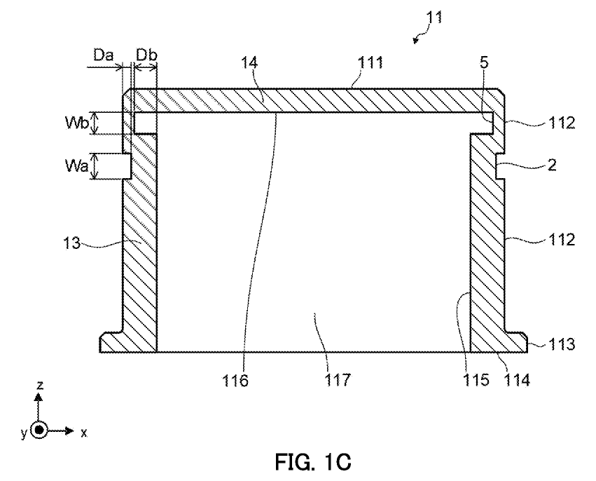

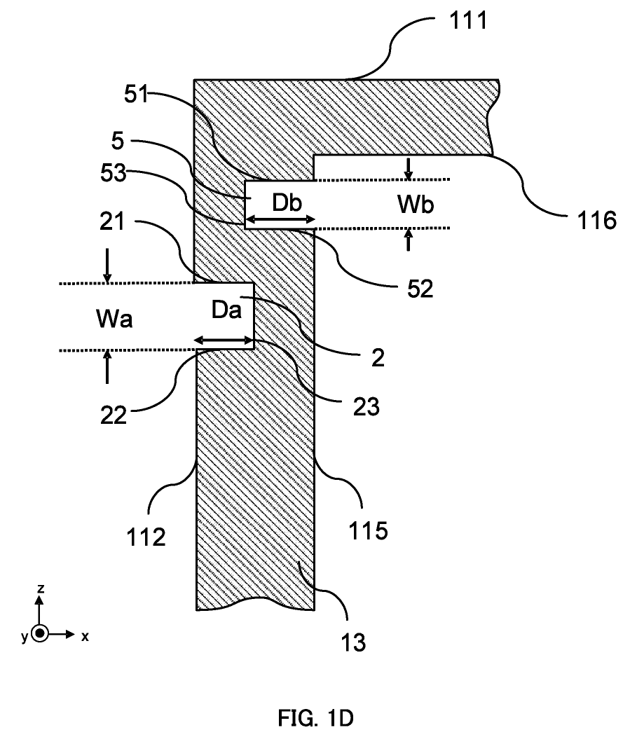

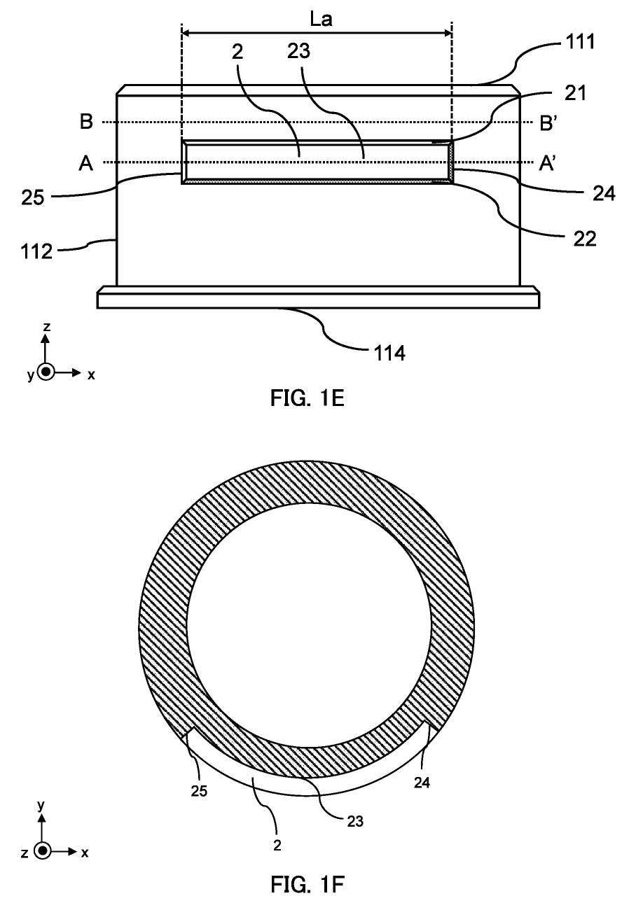

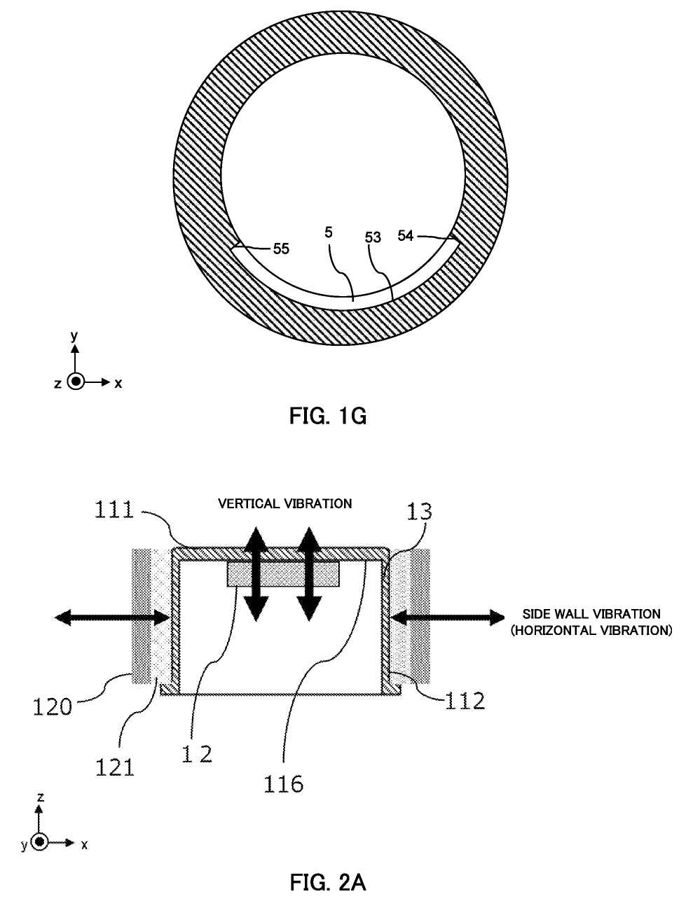

FIG. 1A is a perspective view of ultrasound sensor case (case) 11 according to the embodiment. FIG. 1B is a side view of ultrasound sensor case 11 according to the embodiment. FIG. 1C is a cross-sectional view of ultrasound sensor case 11 according to the embodiment. FIG. 1D is an enlarged cross-sectional view of ultrasound sensor case 11 according to the embodiment. Note that, in FIGS. 1A to 1D, a piezoelectric element that generates an ultrasonic wave is not illustrated.

### Ultrasound Sensor apparatus 10

Ultrasound sensor apparatus 10 is an apparatus for measuring the position of an object and the distance to object using an ultrasonic wave, and functions as an ultrasound transceiver. Ultrasound sensor apparatus 10 includes case 11 as an ultrasound sensor case, a piezoelectric element, processing circuitry, and a lead wire. Ultrasound sensor apparatus 10 generates an ultrasonic wave using the piezoelectric element provided on inner bottom surface 116 of case 11, and transmits an ultrasonic wave toward a surrounding object. Note that the piezoelectric element is connected to the processing circuitry via the lead wire. The transmitted ultrasonic wave is reflected by the object, ultrasound sensor apparatus 10 receives the reflected wave, and the processing circuitry performs object detection processing and the like. In addition, case 11 has a cavity, but the cavity may be filled with silicone or the like.

### Case 11

As illustrated in FIGS. 1A to 1C, case 11 is a bottomed tubular case having side wall 13 and bottom portion 14. Here, in FIGS. 1A to 1D, the x-axis, the y-axis, and the z-axis form a coordinate system orthogonal to each other. The x-axis direction and the y-axis direction correspond to radial directions of case 11 orthogonal to each other, the x-y plane is parallel to outer bottom surface 111 and inner bottom surface 116, and the z-axis direction indicates a direction perpendicular to the x-y plane. In addition, outer wall surface 112 and inner wall surface 115 extend in parallel to the z-axis direction. Bottom portion 14 has outer bottom surface 111 and inner bottom surface 116. In addition, side wall 13 has outer wall surface 112, protrusion portion 113 protruding from outer wall surface 112, end surface 114, and inner wall surface 115. Case 11 is provided with cavity 117 that is a space defined by inner wall surface 115 and inner bottom surface 116 and is filled with air, silicone, or the like. Non-penetrating outer wall groove 2 is provided on outer wall surface 112. Non-penetrating inner wall groove 5 is provided on inner wall surface 115.

### Non-penetrating outer wall groove 2

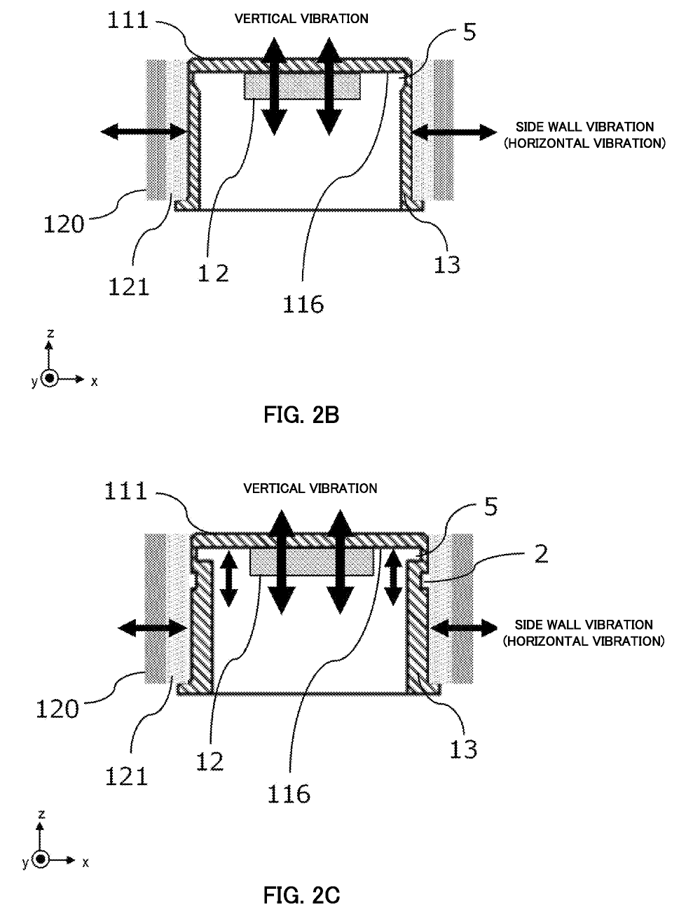

Non-penetrating outer wall groove 2 is a non-penetrating structure such as a groove, a slit, a hole, and a recess portion that is formed on outer wall surface 112 of case 11 and does not penetrate to inner wall surface 115. Since non-penetrating outer wall groove 2 has a non-penetrating structure that does not penetrate from outer wall surface 112 to inner wall surface 115, the ingress of water or foreign matter into case 11 is prevented, and as described with reference to FIGS. 2, the side wall vibration (horizontal vibration) can be reduced in combination with non-penetrating inner wall groove 5 while maintaining the mechanical strength of case 11.

Outer wall surface 112 of case 11 refers to an outer surface of case 11 from outer bottom surface 111 to protrusion portion 113. In a case where protrusion portion 113 is not present, outer wall surface 112 of case 11 refers to an outer surface of case 11 from outer bottom surface 111 to end surface 114.

### Number of non-penetrating outer wall grooves 2

At least one non-penetrating outer wall groove 2 is provided. A plurality of non-penetrating outer wall grooves 2 may be provided.

### Position of non-penetrating outer wall groove 2

Non-penetrating outer wall groove 2 is provided on outer wall surface 112 in a region from inner bottom surface 116 to end surface 114. Non-penetrating outer wall groove 2 may be provided to not overlap non-penetrating inner wall groove 5 in a direction perpendicular to outer bottom surface 111 (z-axis direction), or may be provided to overlap a part of non-penetrating inner wall groove 5. This is to ensure the structural strength of case 11. Similarly, in a case where a plurality of non-penetrating outer wall grooves 2 are provided, the plurality of non-penetrating outer wall grooves 2 may be provided to be spaced from each other. Note that the plurality of non-penetrating outer wall grooves 2 may be continuously disposed.

### Shape of non-penetrating outer wall groove 2

Non-penetrating outer wall groove 2 has a slit shape with a predetermined width, a predetermined length, a predetermined depth, and a predetermined cross-sectional shape. As illustrated in FIGS. 1A to 1D, non-penetrating outer wall groove 2 is an annular slit having a rectangular cross section with constant width Wa and constant depth Da. Note that the width, the depth, and the cross-sectional shape of the slit may be optionally changed according to the shape of case 11. The cross-sectional shape of non-penetrating outer wall groove 2 is not limited to the rectangular cross section as illustrated in FIGS. 1A to 1D. Examples of the cross section of non-penetrating outer wall groove 2 include an arc-shaped cross section, a semicircular cross section, a V-shaped cross section, a U-shaped cross section, and a trapezoidal cross section.

Non-penetrating outer wall groove 2 is not limited to the annular slit that circumferentially surrounds outer wall surface 112 as illustrated in FIGS. 1A to 1D. As described above, non-penetrating outer wall groove 2 may be a recess portion with a predetermined width, a predetermined length, a predetermined depth, and a predetermined cross-sectional shape.

In a case where a plurality of non-penetrating outer wall grooves 2 are provided, the plurality of non-penetrating outer wall grooves 2 may have the same width, length, depth, and cross-sectional shape, or one or more of these may be different from each other.

### Depth Da of non-penetrating outer wall groove 2

FIG. 1D is a cross-sectional view for describing depth Da of non-penetrating outer wall groove 2. As illustrated in FIG. 1D, in a case where non-penetrating outer wall groove 2 has a rectangular cross section, non-penetrating outer wall groove 2 is defined by inner wall surface 21 and inner wall surface 22, which are connected to outer wall surface 112, and bottom surface 23, which is connected to inner wall surface 21 and inner wall surface 22. “Depth Da” of non-penetrating outer wall groove 2 is a distance from outer wall surface 112 to bottom surface 23 of non-penetrating outer wall groove 2 along a direction perpendicular to outer wall surface 112 of case 11 (x direction), for example, a normal direction (radial direction) of outer wall surface 112. Depth Da of non-penetrating outer wall groove 2 can be set, for example, according to the thickness of side wall 13 of case 11. It is preferable that depth Da of non-penetrating outer wall groove 2 is set within a range in which the structural strength of case 11 is ensured.

In addition, depth Da of non-penetrating outer wall groove 2 is not limited to being constant as illustrated in FIG. 1D. Depth Da of non-penetrating outer wall groove 2 may be configured to continuously or discontinuously change according to a position along a circumferential direction of non-penetrating outer wall groove 2. Note that the “circumferential direction” is a direction of movement along a circumference of outer bottom surface 111 or inner bottom surface 116. In a case where the cross section of non-penetrating outer wall groove 2 is an arc-shaped cross section, a semicircular cross section, a V-shaped cross section, a U-shaped cross section, or the like, depth Da of non-penetrating outer wall groove 2 is a distance from outer wall surface 112 to a point of the maximum depth.

### Width Wa of non-penetrating outer wall groove 2

As illustrated in FIG. 1D, “width Wa” of non-penetrating outer wall groove 2 is a distance from one inner wall surface 21 to the other inner wall surface 22 of non-penetrating outer wall groove 2 in a direction perpendicular to outer bottom surface 111 or inner bottom surface 116 (z direction). “Width Wa” of non-penetrating outer wall groove 2 is determined, for example, based on the thickness of the outer wall of the case, vibration characteristics, and directivity of an ultrasonic wave.

Width Wa of non-penetrating outer wall groove 2 having a rectangular cross section as illustrated in FIG. 1D is not limited to being constant. Width Wa of non-penetrating outer wall groove 2 may be configured to continuously or discontinuously change according to a position along the circumferential direction of non-penetrating outer wall groove 2. In addition, width Wa of non-penetrating outer wall groove 2 may be configured to continuously or discontinuously change according to a position in the depth direction (radial direction).

In a case where the cross section of non-penetrating outer wall groove 2 is an arc-shaped cross section, a semicircular cross section, a V-shaped cross section, or a U-shaped cross section, width Wa of non-penetrating outer wall groove 2 may change according to depth Da of non-penetrating outer wall groove 2.

### Circumferential length La of non-penetrating outer wall groove 2

FIGS. 1E and 1F are diagrams for describing circumferential length La of non-penetrating outer wall groove 2. FIG. 1E is a side view of an example of an ultrasound sensor apparatus including non-penetrating outer wall groove 2 having length La, and FIG. 1F is a cross-sectional view of the ultrasound sensor apparatus taken along a line A-A' of FIG. 1E. As illustrated in FIGS. 1E and 1F, in a case where non-penetrating outer wall groove 2 has a slit shape with predetermined length La along the circumferential direction, non-penetrating outer wall groove 2 is defined by inner wall surface 21 and inner wall surface 22 connected to outer wall surface 112 and extending in the longitudinal direction, inner wall end surface 24 and inner wall end surface 25 that are a start point and an end point, respectively, of non-penetrating outer wall groove 2 in the longitudinal direction, and bottom surface 23 connected to the four surfaces.

Circumferential length La of non-penetrating outer wall groove 2 is a distance from inner wall end surface 24 that is one end of non-penetrating outer wall groove 2 to inner wall end surface 25 that is the other end in the circumferential direction. As illustrated in FIGS. 1A to 1D, in a case where non-penetrating outer wall groove 2 is a ring-shaped groove that circumferentially surrounds outer wall surface 112 of case 11, the length of non-penetrating outer wall groove 2 depends on the outer diameter of case 11. Note that non-penetrating outer wall groove 2 is not limited to the annular structure that circumferentially surrounds outer wall surface 112 of case 11. As illustrated in FIGS. 1E and 1F, non-penetrating outer wall groove 2 may be a discontinuous slit having a predetermined length.

### Direction of non-penetrating outer wall groove 2

The direction of non-penetrating outer wall groove 2 is the longitudinal direction of non-penetrating outer wall groove 2. As illustrated in FIGS. 1A to 1G, the direction of non-penetrating outer wall groove 2 is not limited to a direction parallel to outer bottom surface 111. The direction of non-penetrating outer wall groove 2 may change in a zigzag pattern or in a curved manner.

### Non-penetrating inner wall groove 5

Non-penetrating inner wall groove 5 is a non-penetrating structure such as a groove, a slit, a hole, and a recess portion that is formed on inner wall surface 115 of case 11 and does not penetrate to outer wall surface 112. Since non-penetrating inner wall groove 5 has a non-penetrating structure that does not penetrate from inner wall surface 115 to outer wall surface 112, the ingress of water or foreign matter into case 11 is prevented, and as described in FIGS. 2, the side wall vibration (horizontal vibration) can be reduced in combination with non-penetrating outer wall groove 2 while maintaining the mechanical strength of case 11.

Inner wall surface 115 of case 11 refers to an inner surface of case 11 from inner bottom surface 116 to end surface 114.

### Number of non-penetrating inner wall grooves 5

At least one non-penetrating inner wall groove 5 is provided. A plurality of non-penetrating inner wall grooves 5 may be provided.

### Position of non-penetrating inner wall groove 5

Non-penetrating inner wall groove 5 is provided on inner wall surface 115 in a region from inner bottom surface 116 to end surface 114. Note that non-penetrating inner wall groove 5 may be provided to not overlap non-penetrating outer wall groove 2 in a direction perpendicular to outer bottom surface 111 (z-axis direction), or may be provided to overlap a part of non-penetrating outer wall groove 2. This is to ensure the structural strength of case 11. Similarly, in a case where a plurality of non-penetrating inner wall grooves 5 are provided, the plurality of non-penetrating inner wall grooves 5 may be provided to be spaced from each other, or the plurality of non-penetrating inner wall grooves 5 may be continuously disposed.

### Shape of non-penetrating inner wall groove 5

Non-penetrating inner wall groove 5 has a slit shape with a predetermined width, a predetermined length, a predetermined depth, and a predetermined cross-sectional shape. As illustrated in FIGS. 1A to 1D, non-penetrating inner wall groove 5 is an annular slit having a rectangular cross section with constant width Wb and constant depth Db. Note that the width, the depth, and the cross-sectional shape of the slit may be optionally changed according to the shape of case 11. The cross-sectional shape of non-penetrating inner wall groove 5 is not limited to the rectangular cross section as illustrated in FIGS. 1A to 1D. Examples of the cross section of non-penetrating inner wall groove 5 include an arc-shaped cross section, a semicircular cross section, a V-shaped cross section, a U-shaped cross section, and a trapezoidal cross section.

Non-penetrating inner wall groove 5 is not limited to the annular slit that circumferentially surrounds inner wall surface 115 as illustrated in FIGS. 1A to 1D. As described above, non-penetrating inner wall groove 5 may be a recess portion with a predetermined width, a predetermined length, a predetermined depth, and a predetermined cross-sectional shape.

In a case where a plurality of non-penetrating inner wall grooves 5 are provided, the plurality of non-penetrating inner wall grooves 5 may have the same width, length, depth, and cross-sectional shape, or one or more of these may be different from each other.

### Depth Db of non-penetrating inner wall groove 5

As illustrated in FIG. 1D, in a case where non-penetrating inner wall groove 5 has a rectangular cross section, non-penetrating inner wall groove 5 is defined by inner wall surface 51 and inner wall surface 52, which are connected to inner wall surface 115, and bottom surface 53, which is connected to inner wall surface 51 and inner wall surface 52.

“Depth Db” of non-penetrating inner wall groove 5 is a distance from inner wall surface 115 to bottom surface 53 along a direction perpendicular to inner wall surface 115 of case 11, for example, a normal direction (radial direction) of inner wall surface 115. Depth Db of non-penetrating inner wall groove 5 can be set, for example, according to the thickness of side wall 13 of case 11. It is preferable that depth Db of non-penetrating inner wall groove 5 is set within a range in which the structural strength of case 11 is ensured.

Depth Db of non-penetrating inner wall groove 5 is not limited to being constant as illustrated in FIGS. 1A to 1D. Depth Db of non-penetrating inner wall groove 5 may be configured to continuously or discontinuously change according to a position along the circumferential direction of non-penetrating inner wall groove 5.

In a case where the cross section of non-penetrating inner wall groove 5 is an arc-shaped cross section, a semicircular cross section, a V-shaped cross section, or a U-shaped cross section, depth Db of non-penetrating inner wall groove 5 is a distance from inner wall surface 115 to a point of the maximum depth.

### Width Wb of non-penetrating inner wall groove 5

As illustrated in FIG. 1D, “width Wb” of non-penetrating inner wall groove 5 is a distance from one inner wall surface 51 to the other inner wall surface 52 of non-penetrating inner wall groove 5 in a direction perpendicular to inner bottom surface 116. “Width Wb” of non-penetrating inner wall groove 5 is determined, for example, based on the thickness of the outer wall of the case, vibration characteristics, and directivity of an ultrasonic wave.

Width Wb of non-penetrating inner wall groove 5 is not limited to being constant as illustrated in FIGS. 1A to 1D. Width Wb of non-penetrating inner wall groove 5 may be configured to continuously or discontinuously change according to a position along the circumferential direction of non-penetrating inner wall groove 5. In addition, width Wb of non-penetrating inner wall groove 5 may be configured to continuously or discontinuously change according to a position in the depth direction.

In a case where the cross section of non-penetrating inner wall groove 5 is an arc-shaped cross section, a semicircular cross section, a V-shaped cross section, or a U-shaped cross section, width Wb of non-penetrating inner wall groove 5 may change according to its depth Db.

### Circumferential length of non-penetrating inner wall groove 5

FIG. 1G is a cross-sectional view of an example of the ultrasound sensor apparatus taken along a line B-B' of FIG. 1E. As illustrated in FIG. 1G, the circumferential length of non-penetrating inner wall groove 5 is a distance from inner wall end surface 24 that is one end of non-penetrating inner wall groove 5 to inner wall end surface 25 that is the other end in the circumferential direction of case 11, or a distance from one end to the other end of non-penetrating inner wall groove 5 in the longitudinal direction of non-penetrating inner wall groove 5, as in the example of non-penetrating outer wall groove 2 of FIG. 1F. As illustrated in FIGS. 1A to 1D, in a case where non-penetrating inner wall groove 5 is a ring-shaped groove that circumferentially surrounds inner wall surface 115 of case 11, the length of non-penetrating inner wall groove 5 depends on an inner diameter of case 11. Note that non-penetrating inner wall groove 5 is not limited to the structure that circumferentially surrounds inner wall surface 115 of case 11. Non-penetrating inner wall groove 5 may be a discontinuous slit with a predetermined length.

### Direction of non-penetrating inner wall groove 5

The direction of non-penetrating inner wall groove 5 is the longitudinal direction of non-penetrating inner wall groove 5. As illustrated in FIGS. 1A to 1G, the direction of non-penetrating inner wall groove 5 is not limited to a direction parallel to outer bottom surface 111 or inner bottom surface 116. The direction of non-penetrating inner wall groove 5 may change in a zigzag pattern or in a curved manner.

### Side wall vibration in case of no water ingress

The vibration energy generated from piezoelectric element 12 is consumed by the side wall vibration, and it is thus difficult to efficiently transmit the energy of the vertical vibration in the outer bottom surface direction. This reduces the sound pressure of an ultrasonic wave emitted from outer bottom surface 111, resulting in deterioration in the detection ability.

Further, an unintended sound wave (for example, secondary resonance at a frequency different from the main resonance due to the vertical vibration) may be generated due to the side wall vibration, which may affect the detection performance. The unintended sound wave may be mixed with a reflected wave reflected by an obstacle, and the detection by an ultrasound sensor may be unstable, which may lead to false positive or reduced detection accuracy. Note that an ultrasound sensor of the related art is additionally provided with a configuration for removing the unintended sound wave due to the side wall vibration, but this is one factor contributing to increased costs.

### Side wall vibration in case of water ingress

In a case where water is retained between outer wall surface 112 of case 11 and rubber 120 and the side wall vibration occurs, piezoelectric element 12 is affected by the side wall vibration. For example, a relative movement between water 121 and rubber 120 causes resonance or unnecessary movement, and this vibration is transmitted to piezoelectric element 12, which extends the reverberation time, for example, and causes generation of a false positive signal. Note that rubber 120 functions to protect ultrasound sensor case 11 and to absorb the impact in a case of being in contact with another member on which ultrasound sensor case 11 is mounted. In addition, rubber 120 is a member for ensuring the durability and performance stability of the sensor by isolating ultrasound sensor case 11 from moisture or foreign matter.

Some of the energy consumed by the side wall vibration is absorbed by rubber 120 and water 121, and the rest of the energy is transmitted to side wall 13 or outer bottom surface 111 via side wall 13 as an unintended sound wave and is emitted from outer bottom surface 111. The unintended sound wave may be mixed with a reflected wave reflected by an obstacle (detected object), and the detection by the ultrasound sensor may be unstable, which may lead to false positive or reduced detection accuracy.

Note that repeated side wall vibrations make it easier for rubber 120 to be worn, which may result in a reduced sealing performance. It accelerates aging of rubber 120, accordingly. In addition, irregular movement of water 121 due to the vibration increases the risk of moisture entering the apparatus, which may result in a deteriorated waterproof performance of the entire apparatus.

The influence of the vibration by piezoelectric element 12 provided in ultrasound sensor case 11 according to the embodiment will be described with reference to FIGS. 2A, 2B, and 2C. In FIGS. 2A to 2C, the x-axis, the y-axis, and the z-axis form a coordinate system orthogonal to each other. The x-axis direction and the y-axis direction correspond to radial directions of outer bottom surface 111 and inner bottom surface 116 of case 11 orthogonal to each other, the x-y plane is parallel to outer bottom surface 111 and inner bottom surface 116, and the z-axis direction indicates a direction perpendicular to the x-y plane. In addition, outer wall surface 112 and inner wall surface 115 extend in parallel to the z-axis direction. Note that FIGS. 2 illustrate a state in which water is retained between outer wall surface 112 of case 11 and rubber 120, but the side wall vibration occurs without water 121 as well.

FIG. 2A is a cross-sectional view for describing the influence of the vibration of piezoelectric element 12 in Comparative Example 1 in which non-penetrating inner wall groove 5 and non-penetrating outer wall groove 2 are not provided on inner wall surface 115 and outer wall surface 112. As illustrated in FIG. 2A, piezoelectric element 12 provided on inner bottom surface 116 vibrates along an axial direction (z-axis direction) (hereinafter, referred to as a vertical vibration) in response to an applied drive voltage to generate an ultrasonic wave. The “axial direction (z-axis direction)” indicates a direction perpendicular to inner bottom surface 116 or outer bottom surface 111 on which piezoelectric element 12 is mounted. For example, the normal direction of inner bottom surface 116 or outer bottom surface 111 corresponds to the “axial direction (z-axis direction)”. The vertical vibration is transmitted to outer bottom surface 111, and the ultrasonic wave generated by outer bottom surface 111 vibrating in the vertical direction is used for detecting an obstacle, measuring a distance, and the like. The generated ultrasonic wave is reflected by an object, and piezoelectric element 12 receives the reflected wave through outer bottom surface 111 and inner bottom surface 116 and measures the time, thereby realizing a function to measure the position of the object and the distance to the object.

The vibration of piezoelectric element 12 also affects side wall 13 of case 11. The vertical vibration of piezoelectric element 12 transmits the vibration energy to side wall 13 of case 11. As a result, side wall 13 vibrates along a direction that is perpendicular to inner wall surface 115 or outer wall surface 112 and is horizontal to outer bottom surface 111 or inner bottom surface 116 (hereinafter, referred to as a side wall vibration or a horizontal vibration). Note that the horizontal vibration is a vibration in the x-y plane.

In ultrasound sensor case 11 in FIG. 2B according to Comparative Example 2, side wall 13 is generally thicker than that in FIG. 2A to reduce the side wall vibration. Here, in ultrasound sensor case 11 in FIG. 2B, non-penetrating inner wall groove 5 is provided on inner wall surface 115 to compensate for the spread directivity due to the thickening of the side wall. Note that non-penetrating outer wall groove 2 is not provided on outer wall surface 112. The influence of the side wall vibration by piezoelectric element 12 in FIG. 2B will be described. As illustrated in FIG. 2B, piezoelectric element 12 provided on inner bottom surface 116 vibrates vertically as in FIG. 2A.

The vibration of piezoelectric element 12 also affects side wall 13 of case 11. The vertical vibration of piezoelectric element 12 is transmitted to side wall 13 of case 11. Since side wall 13 of case 11 in FIG. 2B is generally thicker than that in FIG. 2A, the side wall vibration is reduced, but a portion of side wall 13 on which non-penetrating inner wall groove 5 is provided is thinner than the other portions, so that the side wall vibration (horizontal vibration) may be large at that portion. The occurrence of the side wall vibration may cause the interference between water 121 and rubber 120 as in FIG. 2A.

In FIG. 2C according to the embodiment, side wall 13 is configured to be thicker than that in FIG. 2A as in FIG. 2B. In FIG. 2C, non-penetrating inner wall groove 5 and non-penetrating outer wall groove 2 are provided on inner wall surface 115 and outer wall surface 112, respectively. The influence of the side wall vibration by piezoelectric element 12 in FIG. 2C will be described. As illustrated in FIG. 2C, side wall 13 may have a structure that makes the vibration in a direction perpendicular to the bottom surface easier due to non-penetrating inner wall groove 5 and non-penetrating outer wall groove 2. Therefore, in case 11 in FIG. 2C, non-penetrating inner wall groove 5 and non-penetrating outer wall groove 2 function as a vibration absorption structure that changes transmission of the vibration to the side wall to the vibration in the direction perpendicular to the bottom surface and absorb the vibration to the side wall. This means that the side wall vibration is reduced and the reduced vibration energy of the side wall is efficiently consumed as the vibration energy in the vertical direction on the bottom surface.

As described above, in FIG. 2C, the vibration of side wall 13 can be reduced more effectively than in FIG. 2B due to non-penetrating inner wall groove 5 and non-penetrating outer wall groove 2. As a result, even in a case of the ingress of water 121 between side wall 13 and rubber 120 as in FIG. 2C, the interference between side wall 13, water 121, and rubber 120 can be reduced, thereby reducing generation of a false positive signal in a case of water ingress.

Further, even without water 121, the spread of the directivity due to the side wall vibration can be reduced, and the narrowing of the directivity can also be expected. In addition, by providing non-penetrating inner wall groove 5 and non-penetrating outer wall groove 2, the vertical vibration of piezoelectric element 12 can be efficiently used as the energy in the vertical direction on the bottom surface. As a result, it may be possible to increase the sound pressure and improve the detection distance (detectable distance) and the like.

In addition, non-penetrating inner wall groove 5 and non-penetrating outer wall groove 2 also play a role in dispersing and attenuating the energy before the vibration reaches the side wall of the case. The groove portion partially absorbs the vibration energy from piezoelectric element 12, and thus the intensity of the vibration transmitted to the side wall is significantly reduced. For example, in a case where non-penetrating inner wall groove 5 and non-penetrating outer wall groove 2 are alternately disposed in an S-shape or a bellows shape, the vibration is gradually absorbed, and the side wall of the case is stabilized without resonance. This reduces the side wall vibration and prevents unnecessary energy leakage toward the outside of the case, thereby improving the detection accuracy as a sensor. In addition, it is possible to reduce the vibration energy consumed by the side wall vibration on side wall 13 of the case in a case of water ingress, thereby increasing the sound pressure of an ultrasonic wave generated from outer bottom surface 111, improving the detection ability, and achieving the narrowing of the directivity.

### Variation 1

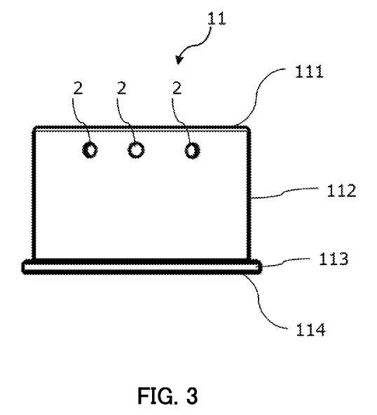

According to Variation 1 of ultrasound sensor case 11 of the embodiment, at least one of non-penetrating inner wall groove 5 and/or non-penetrating outer wall groove 2 is discontinuously disposed along the circumferential direction of case 11. FIG. 3 is a side view of ultrasound sensor case 11 according to Variation 1 of the embodiment. As illustrated in FIG. 3, ultrasound sensor case 11 according to Variation 1 includes non-penetrating outer wall grooves 2 as a plurality of holes. The plurality of holes, which are non-penetrating outer wall grooves 2, are discontinuously disposed in parallel to outer bottom surface 111 along the circumferential direction of outer wall surface 112. Although not illustrated in FIG. 3, a plurality of holes may also be provided on inner wall surface 115 as non-penetrating inner wall grooves 5.

The number of the plurality of holes may be any number. The plurality of holes may be disposed concentrically at equal intervals in the circumferential direction or may be disposed randomly. The shape of the plurality of holes may be circular as illustrated in FIG. 3, or may be, for example, a polygon, an ellipse, a slit shape, a star shape, or a combination thereof. The shapes of all the plurality of holes need not be the same.

The plurality of holes may be disposed in concentric circles in parallel to outer bottom surface 111 along the circumferential direction of outer wall surface 112, may be disposed in a zigzag pattern so that the plurality of holes are disposed in the circumferential direction changing in the positions alternately in a direction perpendicular to outer bottom surface 111, or may be disposed spirally.

Note that non-penetrating inner wall grooves 5 and non-penetrating outer wall grooves 2 may have the same or different shapes, disposition patterns, sizes, and/or depths.

According to ultrasound sensor case 11 of Variation 1, either non-penetrating inner wall grooves 5 or non-penetrating outer wall grooves 2 or both of them are discontinuously disposed, so that reduced vertical vibration of piezoelectric element 12 is transmitted to the side wall of case 11 as the side wall vibration (horizontal vibration). The discontinuous grooves make a plurality of points for reducing the side wall vibration on the side wall, and thus the side wall vibration is unlikely to occur and unnecessary energy leakage to the side wall is prevented.

Since the discontinuous groove structure divides a vibration path when the vibration is transmitted to the side wall, the vibration energy can be prevented from leaking in an unintended direction. In addition, the discontinuous grooves also have an effect of absorbing the vibration energy, thereby reducing an unnecessary vibration of case 11 and improving the directivity of the sensor. The groove disposition on the outer circumference and/or the inner circumference of case 11 controls a radiation direction of an ultrasonic wave, and thus the energy is likely to be concentrated in a specific direction. As a result, the directivity of the ultrasonic wave can be structurally controlled toward the specific direction.

In addition, the discontinuous disposition makes it possible to ensure the mechanical strength of case 11 and reduce the processing cost as compared with the continuous disposition.

### Variations 2A and 2B

In ultrasound sensor case 11 according to Variation 2A, non-penetrating inner wall groove 5 is positioned farther from inner bottom surface 116 than non-penetrating outer wall groove 2. In ultrasound sensor case 11 according to Variation 2B, non-penetrating inner wall groove 5 is positioned closer to inner bottom surface 116 than non-penetrating outer wall groove 2. Note that the description will be given under the assumption that the sizes of cases 11 of Variation 2A and Variation 2B are the same although the positions of non-penetrating inner wall groove 5 and non-penetrating outer wall groove 2 are different between Variation 2A and Variation 2B.

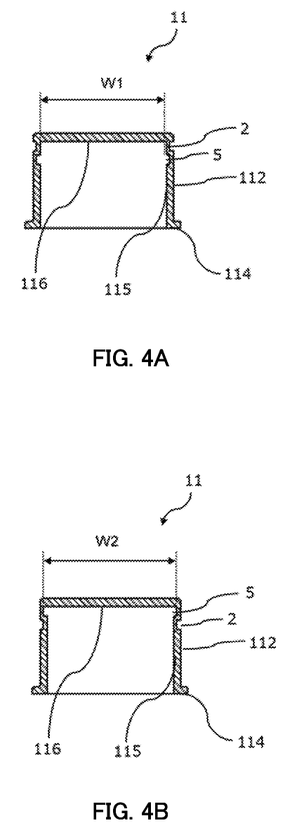

FIG. 4A is a cross-sectional view of ultrasound sensor case 11 according to Variation 2A in which non-penetrating inner wall groove 5 is positioned farther from inner bottom surface 116 than non-penetrating outer wall groove 2. FIG. 4B is a cross-sectional view of ultrasound sensor case 11 according to Variation 2B in which non-penetrating inner wall groove 5 is positioned closer to inner bottom surface 116 than non-penetrating outer wall groove 2.

As illustrated in FIG. 4A, according to Variation 2A, the width of inner bottom surface 116 and the width of inner wall surface 115 are W1 and match each other. In contrast, according to Variation 2B, non-penetrating inner wall groove 5 is provided to be continuous with inner bottom surface 116, and thus width W2 of inner bottom surface 116 is expanded according to the depth of non-penetrating inner wall groove 5. Therefore, the width of inner bottom surface 116, for example, the width of a vibration surface of Variation 2B is larger than that of Variation 2A.

Regarding the directivity of an ultrasonic wave in an in-vehicle ultrasound sensor apparatus of the related art, the vertical directivity (the direction perpendicular to outer bottom surface 111) is narrowed so as not to detect the road surface while the horizontal directivity is set wide so as to be able to detect lateral obstacles. In addition, an ultrasound sensor apparatus of the related art including those other than the in-vehicle ultrasound sensor apparatus has a characteristic that the directivity in the vertical direction is narrowed as the width of the vibration surface is increased. Note that the directivity being narrow means that the angle (beam angle) of an emitted ultrasonic wave is small.

According to Variation 2B, the vibration surface can be increased as compared with Variation 2A, so that the directivity in the vertical direction can be narrowed as compared with Variation 2A. Further, since the width of inner bottom surface 116 (width of the vibration surface) is expanded according to the configuration of Variation 2B, the sound pressure of an ultrasonic wave obtained by Variation 2B can be increased as compared with the sound pressure of an ultrasonic wave obtained by Variation 2A. As a result, it is possible to expect an increase in the detection distance, and responsiveness to a remote obstacle can also be improved.

### Variation 3

In ultrasound sensor case 11 according to Variation 3, assuming that the distance from inner bottom surface 116 of case 11 to end surface 114 of case 11 is 100%, non-penetrating inner wall groove 5 is disposed on inner wall surface 115 at a distance of 20% or less from inner bottom surface 116 of case 11.

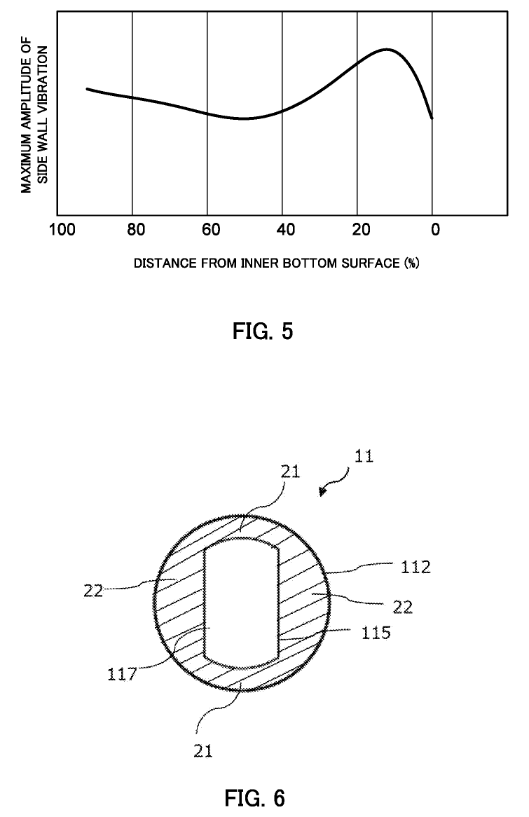

FIG. 5 is an example of a simulation showing the distance dependence in the vertical direction of the maximum amplitude of the side wall vibration in the ultrasound sensor apparatus without the groove. The horizontal axis of the graph indicates the distance from inner bottom surface 116. Here, 0% corresponds to the position of inner bottom surface 116 of case 11, and 100% corresponds to the position of end surface 114 of case 11. The vertical axis indicates the maximum amplitude of the side wall vibration. In the ultrasound sensor apparatus without the groove, when the vibration surface (inner bottom surface 116) vibrates, the vibration is transmitted to the side wall, and the side wall vibrates. As illustrated in FIG. 5, it is confirmed that the maximum amplitude of the vibration shows a peak at a position of about 10%, is reduced toward 50%, and gradually increases beyond 50%.

According to Variation 3, non-penetrating inner wall groove 5 is provided at a distance of 20% or less with reference to inner bottom surface 116 of case 11, based on the simulation. Since non-penetrating inner wall groove 5 blocks the propagation path of the side wall vibration, the side wall vibration can be reduced as a whole while effectively suppressing the peak of the side wall vibration.

In addition, when the side wall vibration is large, the vibration interferes with ultrasonic wave oscillation of piezoelectric element 12, and the detection accuracy may be deteriorated. By reducing the side wall vibration, ultrasonic wave oscillation from the vibration surface (inner bottom surface 116) is stabilized, resulting in stable detection of a reflected wave.

Further, by reducing the side wall vibration, the interference with water between rubber 120 and case 11 is reduced, resulting in an improved waterproof performance (for example, reduced false positive signal generation in a case of water ingress). This contributes to the implementation of an ultrasound sensor apparatus that is less affected by the external environment.

In addition, the side wall vibration may accelerate the fatigue of case 11 and may cause the deterioration of case 11 or the internal structure. By reducing the side wall vibration, the fatigue of the material is reduced, and the life of the apparatus may be extended.

### Variation 4

In ultrasound sensor case 11 according to Variation 4, case 11 includes a thick wall portion at which the side wall is thick and a thin wall portion at which the side wall is thin. The “thick wall portion at which the side wall is thick” refers to a portion of the side wall having a larger thickness than other portions. The “thin wall portion at which the side wall is thin” refers to a portion of the side wall having a smaller thickness than other portions.

FIG. 6 is a planar cross-sectional view of ultrasound sensor case 11 according to Variation 4. In the planar cross-sectional view of FIG. 6, ultrasound sensor case 11 has a cylindrical cross section with cavity 117 at the center of case 11, the outer circumference circle corresponds to outer wall surface 112 of the case, and the closed line defining cavity 117 corresponds to inner wall surface 115. Note that, in FIG. 6, non-penetrating inner wall groove 5 and non-penetrating outer wall groove 2 are omitted for describing thin wall portion 21 and thick wall portion 22.

Two thin wall portions 21 that face each other through cavity 117 are provided between outer wall surface 112 and inner wall surface 115 of case 11. Inner wall surfaces 115 of two thin wall portions 21 are defined by an arc of a circle or an ellipse having a radius smaller than the radius of outer wall surface 112. Note that the thickness of thin wall portion 21 may be uniform or non-uniform.

In addition, two thick wall portions 22 that face each other through cavity 117 and have a thickness equal to or larger than the thickness of thin wall portion 21 are provided between outer wall surface 112 and inner wall surface 115 of case 11. Since inner wall surfaces 115 of two thick wall portions 22 are straight lines in the planar cross-sectional view, the width of cavity 117 defined by inner wall surfaces 115 of two thick wall portions 22 is constant.

For example, cavity 117 is in a rectangular shape with short arc-shaped sides. Since the planar shape of cavity 117 and the planar shape of inner bottom surface 116 match each other, the planar shape of inner bottom surface 116 is the same as that of cavity 17.

According to Variation 4 including inner bottom surface 116 having such a shape, the width of the vibration surface (inner bottom surface 116) is wide in a direction along the long sides of cavity 117, and the width of the vibration surface is narrow in a direction along the short sides of cavity 117. As a result, the directivity of an ultrasonic wave can be narrowed by increasing the width of the vibration surface (inner bottom surface 116) in the long side direction, and the directivity of an ultrasonic wave can be widened by decreasing the width of the vibration surface in the short side direction.

According to Variation 4, since cavity 117 of case 11 is in a rectangular shape with short arc-shaped sides, it is possible to adjust the width of the vibration surface (inner bottom surface 116), thereby enabling the directivity control according to the radiation direction of an ultrasonic wave.

Specifically, by widening the width of the vibration surface in the direction along the long sides of cavity 117, the directivity is narrowed, and ultrasonic waves can be concentrated at long distances. This produces an effect of easily detecting a remote object by the ultrasound sensor apparatus. In contrast, by narrowing the width of the vibration surface in the direction along the short sides of cavity 117, the directivity is widened, and ultrasonic waves can be radiated to a wide area. With this effect, the ultrasound sensor apparatus is also effective in a scene where wide-range detection at a short distance is required.

Note that, although cavity 117 having the shape illustrated in FIG. 6 has been described here, cavity 117 may be in a rectangular shape with long arc-shaped sides or with four arc-shaped sides, for example.

### Variation 5

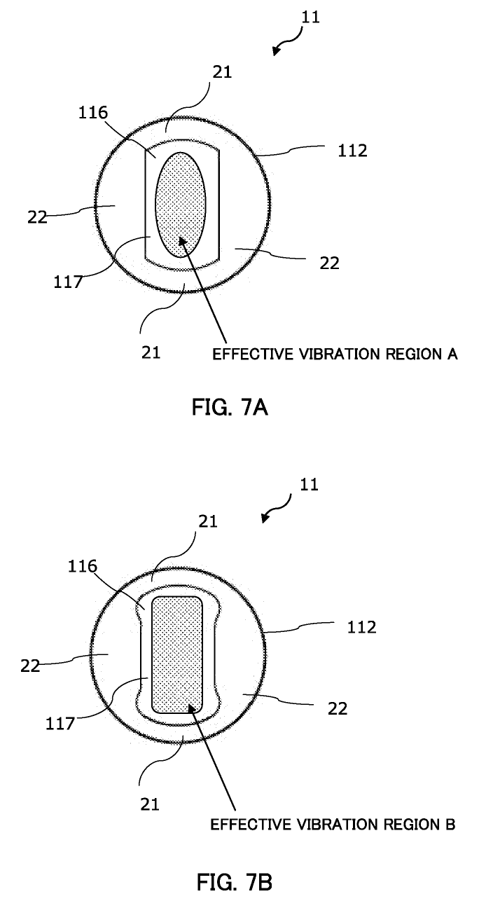

In ultrasound sensor case 11 according to Variation 5, the cross section of cavity 117 has a narrowed portion. The “narrowed portion” refers to a profile in which the middle portion is recessed (narrowed) relative to both ends. FIG. 7A is a plan view illustrating effective vibration region A of the vibration surface (inner bottom surface 116) according to Variation 4 in FIG. 6. FIG. 7B is a plan view illustrating effective vibration region B of the vibration surface (inner bottom surface 116) according to Variation 5. Note that, in FIGS. 7A and 7B, non-penetrating inner wall groove 5 and non-penetrating outer wall groove 2 are omitted.

As illustrated in FIG. 7A, the vibration surface (inner bottom surface 116) in a rectangular shape with short arc-shaped sides according to Variation 4 has elliptical effective vibration region A. Here, the “effective vibration region” refers to a region in which the vibration energy of piezoelectric element 12 is efficiently transmitted and the intensity or the amplitude of the vibration is sufficiently secured, and the effective vibration region affects the detection accuracy and/or the directivity. Since the vibration is attenuated or the energy is diffused in a region outside the effective vibration region, the region outside the effective vibration region does not directly contribute to the performance or the accuracy of the sensor.

As illustrated in FIG. 7B, inner bottom surface 116 according to Variation 5 has a narrowed portion that is narrowed inward on the long sides as compared with the vibration surface (inner bottom surface 116) according to Variation 4 illustrated in FIG. 7A. The narrowed portion makes effective vibration region B wider than effective vibration region A illustrated in FIG. 7A. As a result, the directivity of an ultrasonic wave in the longitudinal direction can be narrowed. In contrast, the directivity of an ultrasonic wave in the shorter direction can be widened.

In addition, the directivity can be different in the longitudinal direction and the shorter direction, resulting in design flexibility which allows for setting the optimal directivity according to a specific detection region or an application. As a result, the application range of the ultrasound sensor apparatus can be expanded according to the purpose.

### Variation 6

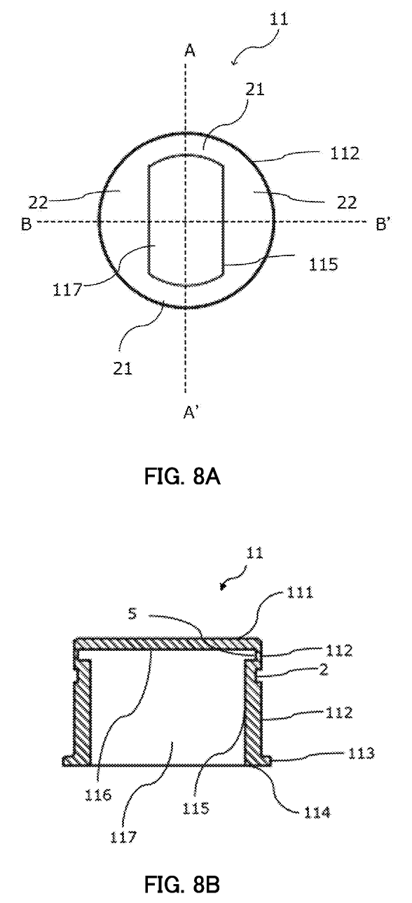

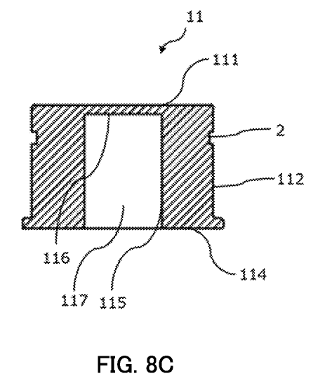

In ultrasound sensor case 11 according to Variation 6, non-penetrating inner wall groove 5 is provided in thin wall portion 21 of case 11. FIG. 8A is a plan view of ultrasound sensor case 11 according to Variation 6 including thin wall portions 21 and thick wall portions 22. FIG. 8B is a cross-sectional view of ultrasound sensor case 11 according to Variation 6, taken along a line A-A' of FIG. 8A. FIG. 8C is a cross-sectional view of ultrasound sensor case 11 according to Variation 6, taken along a line B-B' of FIG. 8A.

As illustrated in FIG. 8A, the side wall determined by outer wall surface 112 and inner wall surface 115 includes two thin wall portions 21 facing each other and two thick wall portions 22 facing each other, and includes cavity 117 in a rectangular shape with short arc-shaped sides.

As illustrated in FIG. 8B, in a cross section cut to include two thin wall portions 21, non-penetrating inner wall groove 5 is provided on inner wall surface 115, and non-penetrating outer wall groove 2 is provided on outer wall surface 112.

As illustrated in FIG. 8C, in a cross section cut to include two thick wall portions 22, non-penetrating inner wall groove 5 is not provided on inner wall surface 115, but non-penetrating outer wall groove 2 is provided on outer wall surface 112. For example, two non-penetrating inner wall grooves 5 are provided respectively on inner wall surfaces 115 corresponding to two thin wall portions 21 that face each other through cavity 117. For example, non-penetrating outer wall groove 2 is provided as a continuous groove around the outer circumference of outer wall surface 112, but non-penetrating inner wall grooves 5 are provided in thin wall portions 21 as discontinuous grooves.

For an in-vehicle ultrasound sensor according to the related art, the directivity of an ultrasonic wave in the vertical direction is narrowed so as not to detect the road surface, and the directivity of an ultrasonic wave in the horizontal direction is set wide so as to detect an obstacle in the left-right direction of a vehicle. In addition, in the in-vehicle ultrasound sensor according to the related art, the directivity of an ultrasonic wave in the vertical direction can be narrowed by increasing the width of the vibration surface, and the directivity in the vertical direction can be widened by decreasing the width of the vibration surface.

According to ultrasound sensor case 11 according to Variation 6, non-penetrating inner wall grooves 5 are provided in a direction along the line A-A', so that the directivity of an ultrasonic wave in the direction along the line A-A' is set to be narrow, and non-penetrating inner wall groove 5 is not provided in a direction along the line B-B', so that the directivity of an ultrasonic wave in the direction along the line B-B' can be maintained to be wide.

In addition, by narrowing the directivity in the direction along the line A-A', ultrasonic waves can be concentrated and radiated farther in this direction. As a result, the energy of ultrasonic waves is efficiently concentrated on an obstacle positioned in the direction along the line A-A', thereby making it easier to detect a distant object.

In contrast, non-penetrating inner wall groove 5 is not provided in the direction along the line B-B', and thus the directivity of an ultrasonic wave in the direction along the line B-B' is maintained to be wide. As a result, ultrasonic waves are radiated over a wide range in the direction along the line B-B', thereby making it easier to simultaneously detect an obstacle present at a short distance and an obstacle in a wide range around the vehicle. This is effective in an application in which the vehicle grasps the surrounding environment or performs detection of an adjacent obstacle.

In addition, ultrasound sensor case 11 with specific directivity improves the adaptability according to the application. For example, obstacles on the side direction or rear direction of the vehicle can be efficiently detected by concentratively detecting a distant obstacle in the vertical direction (direction along the line A-A') and covering a wide range in the horizontal direction (direction along the line B-B'). This enables detection effectively using the directivity in a specific scene and realizes detection depending on the installation environment and/or the application of the sensor.

### Variations 7A and 7B

In ultrasound sensor case 11 according to Variation 7A, non-penetrating inner wall groove 5 and non-penetrating outer wall groove 2 have a rectangular shape. For example, the widths of non-penetrating inner wall groove 5 and non-penetrating outer wall groove 2 do not change according to the depth direction.

In ultrasound sensor case 11 according to Variation 7B, the width of at least one of non-penetrating inner wall groove 5 and/or non-penetrating outer wall groove 2 changes according to the depth direction. The “width changing according to the depth direction” means that the width in the axial direction changes along the depth direction (normal direction of outer wall surface 112 or normal direction of inner wall surface 115) in non-penetrating inner wall groove 5 and non-penetrating outer wall groove 2. Specifically, it means that the width is widened or narrowed as the depth increases or decreases. Examples of the “width changing according to the depth direction” include at least one of non-penetrating inner wall groove 5 and/or non-penetrating outer wall groove 2 having a semicircular, arc-shaped, semi-elliptical, parabolic, V-shaped, U-shaped, trapezoidal, or tapered cross section.

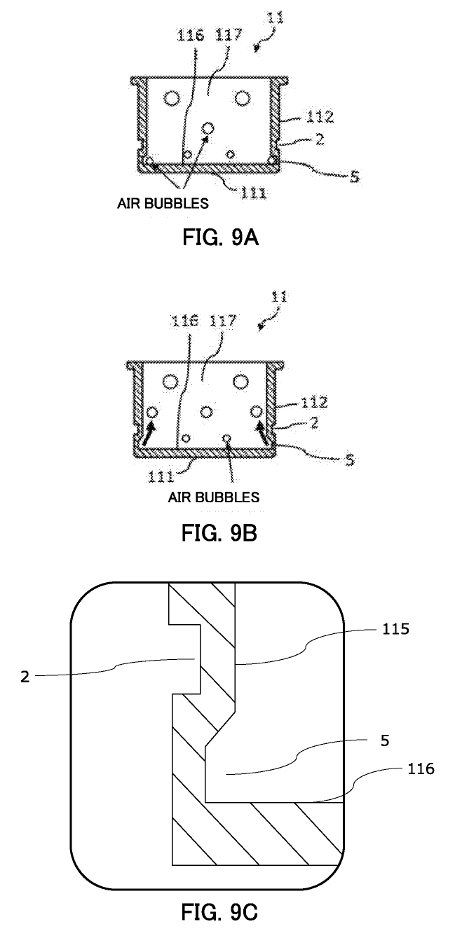

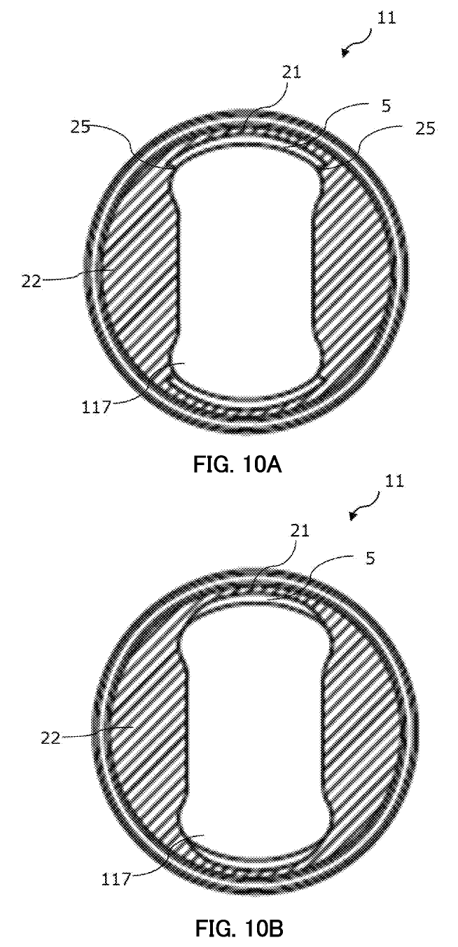

FIG. 9A is a cross-sectional view of ultrasound sensor case 11 according to Variation 7A. As illustrated in FIG. 9A, non-penetrating inner wall groove 5 and non-penetrating outer wall groove 2 each have a rectangular shape. Cavity 117 may be filled with a foaming filler consisting of foaming silicone for adjusting the damping of the vibration surface. The damping adjustment is to adjust an attenuation rate of the vibration to an optimal state in order to efficiently attenuate the vibration. The foaming filler is filled by flowing a liquid filler into the case and solidifying the liquid filler with high temperature, for example. At that time, air bubbles are generated from the foaming filler. In a case where non-penetrating inner wall groove 5 has a rectangular shape, air bubbles may be trapped in non-penetrating inner wall groove 5. As illustrated in FIG. 9A, the air bubble near the vibration surface reduces the damping effect and makes the reverberation time of the vibration (ultrasonic wave) longer, which may deteriorate the performance of detecting an object in a short range. In a case where the vibration is appropriately attenuated by the foaming filler, the reverberation converges in a short time, the sensor does not receive a reflected sound, and the next ultrasonic wave emission is not affected. In a case where the reverberation time is long, the next ultrasonic wave may be emitted before a reflected sound of the previously emitted ultrasonic wave or unnecessary vibration is sufficiently attenuated for a practical purpose. For example, the detection of a short-range object is susceptible to reverberation since an ultrasonic wave is reflected and returns from a target object.

FIG. 9B is a cross-sectional view of ultrasound sensor case 11 according to Variation 7B. FIG. 9C is an enlarged cross-sectional view of non-penetrating inner wall groove 5 of FIG. 9B. FIGS. 9B and 9C are cross-sectional views of ultrasound sensor case 11 according to Variation 7B. As illustrated in FIG. 9C, non-penetrating inner wall groove 5 has a first side surface at the same level as inner bottom surface 116, a bottom surface connected to the first side surface, and an inclined surface between the bottom surface and inner wall surface 115. Since the angle formed by the bottom surface and the inclined surface is an obtuse angle greater than 90 degrees and less than 180 degrees, the width of non-penetrating inner wall groove 5 gradually increases until non-penetrating inner wall groove 5 reaches the level of inner wall surface 115.

According to ultrasound sensor case 11 according to Variation 7B, the structure in which the width of non-penetrating inner wall groove 5 is widened as the depth thereof is shallower facilitates natural movement of air bubbles generated in non-penetrating inner wall groove 5 and near non-penetrating inner wall groove 5 during manufacturing, and the air bubbles are less likely to be trapped near non-penetrating inner wall groove 5. This prevents reduction in the damping effect due to the air bubbles trapped near the vibration surface, and the foaming filler functions appropriately as the damping adjustment by efficiently absorbing the vibration energy. In addition, the reverberation time of an ultrasonic wave is shortened, and the reverberation can be prevented from interfering with reception of a reflected sound or the next ultrasonic wave emission. For example, in the detection of a short-range object, the deterioration in accuracy due to unnecessary reverberation is alleviated, thereby improving the detection performance at a short distance. In addition, since the width of the groove gradually widens, the fluidity of the foaming filler is increased and the foaming filler is easily filled in the entire case uniformly, thereby also improving the uniformity and the quality of the filler in the manufacturing process.

### Variations 8A and 8B

In ultrasound sensor case 11 according to Variation 8, at least one of non-penetrating inner wall groove 5 and/or non-penetrating outer wall groove 2 has an uneven groove depth. The “uneven groove depth” means that the groove depth is not constant and is different depending on the position of the groove.

The “uneven groove depth” is, for example, a stepwise depth structure in which the groove depth changes stepwise (for example, a groove that gradually becomes deeper from a shallow portion), a linear depth structure in which the groove depth changes linearly at a constant gradient, a local depth structure in which a part of the groove is deep and the other parts are shallow or a part of the groove is shallow and the other parts are deep (for example, a groove having an extremely deep portion), a curved depth structure in which the groove depth changes in a curve, or a wave depth structure in which the groove is formed in a wave shape in the depth direction and the groove depth changes periodically.

FIG. 10A is a diagram illustrating a planar cross-sectional view of ultrasound sensor case 11 according to Variation 8A in which the depth of non-penetrating inner wall groove 5 provided in thin wall portion 21 is uniform. In Variation 8A, corner portions (or protrusion portions) 25 are formed at portions where both end portions of non-penetrating inner wall groove 5 are connected to inner wall surface 115. These corner portions 25 are formed by forming a groove from inner wall surface 115 along the outer diameter at both end portions of non-penetrating inner wall groove 5. The vibration of the vibration surface is hindered by corner portions 25 of both end portions, and the effective vibration region of the vibration surface is narrowed. In addition, the narrowed effective vibration region of the vibration surface may reduce the sound pressure of an ultrasonic wave and may hinder the narrowing of the directivity of an ultrasonic wave in the vertical direction. Further, in filling cavity 117 of case 11 with a foaming filler, the flow of the foaming filler is hindered by the corner portions being physical obstacles. As a result, an air bubble may be trapped in non-penetrating inner wall groove 5, which may cause deterioration in the damping performance and deterioration in the detection performance.

FIG. 10B is a diagram illustrating a planar cross-sectional view of ultrasound sensor case 11 according to Variation 8B in which the depth of non-penetrating inner wall groove 5 provided in thin wall portion 21 gradually increases from both end portions toward the center in the circumferential direction. According to Variation 8B, the depth of non-penetrating inner wall groove 5 becomes shallower from the center portion to both end portions, and non-penetrating inner wall groove 5 and inner wall surface 115 are smoothly connected.

According to Variation 8B, the depth is shallow at both end portions of non-penetrating inner wall groove 5 so as to be smoothly connected to inner wall surface 115, and thus the effective vibration region of the vibration surface is ensured to be wider than that in Variation 8A having a uniform thickness. This improves the sound pressure of an ultrasonic wave and enhances the directivity of an ultrasonic wave in the vertical direction.

In addition, the smooth connection to inner wall surface 115 allows for a smooth flow of a foaming filler when filling cavity 117 with the foaming filler during manufacturing, which makes it easier to realize uniform distribution of the foaming filler. As a result, an air bubble is less likely to be trapped in non-penetrating inner wall groove 5, and the damping performance and the detection performance can be improved.

### Variation 9

In ultrasound sensor case 11 according to Variation 9, the width of non-penetrating inner wall groove 5 or non-penetrating outer wall groove 2 or both widths are uneven. The “uneven groove width” means that the width of the cross section of the groove is not constant and varies depending on the position of the groove in the longitudinal direction or the circumferential direction. More specifically, the uneven groove width includes a stepwise width structure in which the groove width changes stepwise (for example, a structure in which the width is widened or narrowed at a constant interval), a linear width structure in which the groove width continuously changes at a constant inclination (for example, a structure in which the width gradually widens from one end to the other end of the groove), a local width change structure in which the groove width is widened or narrowed at a specific position (for example, a structure in which an extremely wide or narrow portion is provided at a specific portion), a curved width structure in which the groove width changes in a curve (for example, a structure in which the width changes in a wave shape along the longitudinal direction of the groove), a wave width structure in which the groove width periodically widens or narrows, and the like.

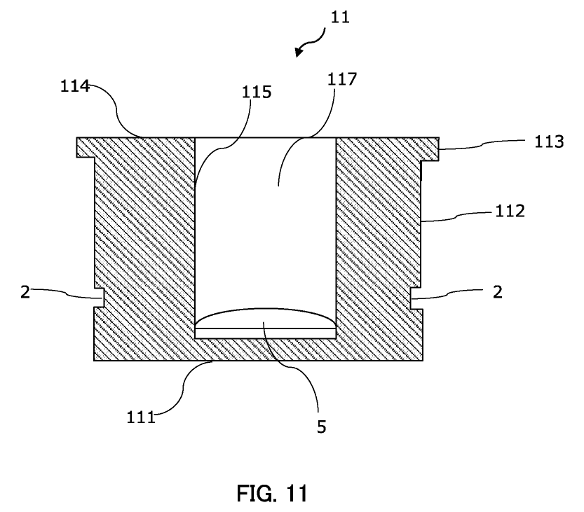

FIG. 11 is a cross-sectional view of ultrasound sensor case 11 according to Variation 9 in which the width of non-penetrating inner wall groove 5 is configured to be widened from both end portions toward the center portion. As illustrated in FIG. 11, the upper end portion of non-penetrating inner wall groove 5 is arc-shaped while the lower end portion is linear, so that the width is widened from both end portions of non-penetrating inner wall groove 5 toward the circumferential center portion.

Ultrasound sensor case 11 according to Variation 9 prevents generation of air bubbles in filling cavity 117 with a foaming filler. In addition, the directivity of an ultrasonic wave in the vertical direction can be narrowed. Further, deterioration in the detection performance for a short-range object can be prevented.

### Variations 10A and 10B

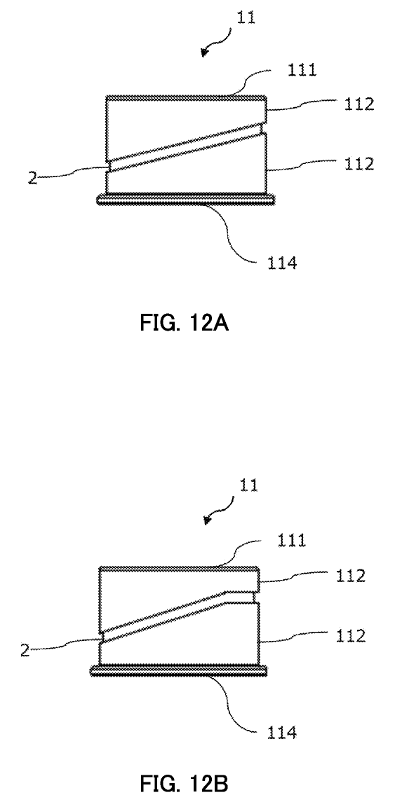

In ultrasound sensor case 11 according to Variation 10A and Variation 10B, at least one of non-penetrating inner wall groove 5 and/or non-penetrating outer wall groove 2 is not parallel to outer bottom surface 111 entirely or has a portion that is not parallel to outer bottom surface 111. FIG. 12A is a side view of ultrasound sensor case 11 according to Variation 10A in which non-penetrating outer wall groove 2 is not parallel to outer bottom surface 111. FIG. 12B is a side view of ultrasound sensor case 11 according to Variation 10B in which non-penetrating outer wall groove 2 has a portion that is parallel to outer bottom surface 111 and a portion that is not parallel to outer bottom surface 111.

As illustrated in FIG. 12A, non-penetrating outer wall groove 2 is not parallel to outer bottom surface 111 entirely and is inclined.

As illustrated in FIG. 12B, non-penetrating outer wall groove 2 is composed of a portion that is parallel to outer bottom surface 111 and a portion that is not parallel to outer bottom surface 111, for example, an inclined portion.

Note that it is desirable that non-penetrating inner wall groove 5 and non-penetrating outer wall groove 2 are provided to be parallel to each other.

The inclination angle between the longitudinal direction in which non-penetrating outer wall groove 2 and non-penetrating inner wall groove 5 extend and outer bottom surface 111 may be any degrees.

As illustrated in the example of FIG. 12A, non-penetrating outer wall groove 2 provided not parallel to the vibration surface effectively reduces the side wall vibration at the thin wall portions near outer bottom surface 111. This reduces unnecessary vibration and facilitates efficient transmission of the vibration energy, thereby improving the transmission and reception performance of the ultrasound sensor. For example, the acoustic characteristics are stabilized in an environment requiring high-accuracy obstacle detection or distance measurement.

Also from the viewpoint of the waterproof performance, the disposition of non-penetrating outer wall groove 2 not parallel to the vibration surface can be effective. For example, in a case where the installation direction of ultrasound sensor case 11 can be considered, it is possible to prevent rainwater from entering through non-penetrating outer wall groove 2 in the upper thin wall portions. Although there is a concern that the water that has entered from the upper part is accumulated in non-penetrating outer wall groove 2 and the waterproof performance is deteriorated, the water can be prevented from being accumulated in non-penetrating outer wall groove 2 by guiding the water to a lower drain hole (not illustrated) through non-penetrating outer wall groove 2 that is not parallel to the vibration surface. With such a design, it is possible to improve the waterproof performance by reducing the vibration as well as prevent deterioration in the waterproof performance due to accumulation of water in non-penetrating outer wall groove 2.

### Variations 11A and 11B

In Variation 11A, at least one of non-penetrating inner wall groove 5 and/or non-penetrating outer wall groove 2 is provided over the entire circumference of inner wall surface 115 or outer wall surface 112 and meanders along the circumferential direction. The “meandering along the circumferential direction” refers to a state in which non-penetrating inner wall groove 5 or non-penetrating outer wall groove 2 is disposed on inner wall surface 115 or outer wall surface 112 in a curved pattern around the circumference instead of being disposed straight along the circumferential direction. Specifically, the meandering includes a waveform pattern in which the groove oscillates periodically in the axial direction and forms a sequence of a plurality of curves, a zigzag pattern in which the direction of the groove continuously changes along the circumferential direction and is folded at a plurality of turning points, and the like.

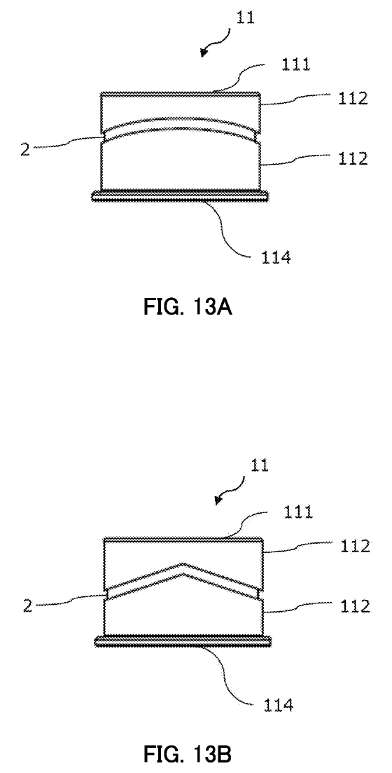

FIG. 13A is a cross-sectional view of ultrasound sensor case 11 according to Variation 11A. As illustrated in FIG. 13A, ultrasound sensor case 11 includes thin wall portions and thick wall portions, and non-penetrating outer wall groove 2 is formed over the entire circumference of outer wall surface 112. Non-penetrating outer wall groove 2 is an arc-shaped slit disposed along the circumferential direction in a curved manner. In addition, non-penetrating outer wall groove 2 in the thin wall portion of outer wall surface 112 has a portion closest to the vibration surface, and non-penetrating outer wall groove 2 in the thick wall portion of outer wall surface 112 has a portion farthest from the vibration surface. For example, non-penetrating outer wall groove 2 has a structure in which a portion closest to the vibration surface and a portion farthest from the vibration surface are alternately disposed in the circumferential direction.

According to ultrasound sensor case 11 according to Variation 11A, non-penetrating outer wall groove 2 is configured to pass near the vibration surface in the thin wall portion with significant vibration from the vibration surface, so that the side wall vibration of the thin wall portion is reduced and the waterproofness is improved. Meanwhile, water may enter non-penetrating outer wall groove 2 itself, which may deteriorate the waterproof performance. However, since ultrasound sensor case 11 is configured such that non-penetrating outer wall groove 2 passes at a position farther from the vibration plate as non-penetrating outer wall groove 2 is away from the center of the thin wall portion, water is unlikely to enter non-penetrating outer wall groove 2.

In addition, in Variation 11B, at least one of non-penetrating inner wall groove 5 and/or non-penetrating outer wall groove 2 is provided over the entire circumference of inner wall surface 115 or outer wall surface 112 and is formed in a zigzag pattern in the circumferential direction. The “formed in a zigzag pattern in the circumferential direction” refers to a state in which non-penetrating inner wall groove 5 or non-penetrating outer wall groove 2 is disposed while continuously drawing a folded line along the circumferential direction on inner wall surface 115 or outer wall surface 112. Specifically, it includes a pattern in which the groove travels straight at a constant angle with respect to the circumferential direction, bents at an obtuse angle, and changes the direction at predetermined intervals.

FIG. 13B is a cross-sectional view of ultrasound sensor case 11 according to Variation 11B. As illustrated in FIG. 13B, ultrasound sensor case 11 includes thin wall portions and thick wall portions, and non-penetrating outer wall groove 2 is formed over the entire circumference of outer wall surface 112. Non-penetrating outer wall groove 2 is a linear slit having a folded structure along the circumferential direction. In addition, non-penetrating outer wall groove 2 in the thin wall portion of outer wall surface 112 has a portion closest to the vibration surface, and non-penetrating outer wall groove 2 in the thick wall portion of outer wall surface 112 has a portion farthest from the vibration surface. For example, non-penetrating outer wall groove 2 has a structure in which a portion closest to the vibration surface and a portion farthest from the vibration surface are alternately disposed in the circumferential direction.

Note that, in Variations 11A and 11B, the interval at which the portion closest to the vibration surface or the portion farthest from the vibration surface appears is 180° as illustrated in FIGS. 13A and 13B, but the present disclosure is not limited thereto. For example, any angle such as 120°, 90°, and 60° may be used. In addition, as illustrated in FIG. 13A, the interval may be determined according to the positions of the thick wall portions of case 11 having thick side walls and the thin wall portions of case 11 having side walls thinner than those of the thick wall portions.

In addition, in Variations 11A and 11B, as illustrated in FIGS. 13A and 13B, the width in the axial direction and the depth of the slit are exemplified as being the same, but the present disclosure is not limited thereto. The width and the depth of the slit may be configured to be varied depending on the interval at which the portion closest to the vibration surface or the portion farthest from the vibration surface appears, for example. For example, the width may be gradually widened or narrowed toward the portion closest to the vibration surface.

The configurations described in the above embodiments and Variations are merely examples, and can be combined with other known technologies, can be combined with each other, and can also omit or change a part of the configurations within a range not departing from the gist.

This application is entitled to the benefit of Japanese Patent Application No.2024-227595, filed on December 24, 2024, the disclosures of which including the specification, drawings and abstract are incorporated herein by reference in their entirety.

### Industrial Applicability

The present disclosure can be widely used in an ultrasound sensor apparatus.

### Reference Signs List

2 Non-penetrating outer wall groove

5 Non-penetrating inner wall groove

11 Ultrasound sensor case

12 Piezoelectric element

13 Side wall

14 Bottom portion

21 Thin wall portion

22 Thick wall portion

111 Outer bottom surface

112 Outer wall surface

113 Protrusion portion

114 End surface

115 Inner wall surface

116 Inner bottom surface

117 Cavity

120 Rubber

121 Water

1. An ultrasound sensor case comprising:
a bottom portion; and
a side wall connected to the bottom portion, wherein,
the side wall is formed with a non-penetrating inner wall groove on an inner wall surface of the side wall and a non-penetrating outer wall groove on an outer wall surface of the side wall, the non-penetrating inner wall groove not penetrating to the outer wall surface, and the non-penetrating outer wall groove not penetrating to the inner wall surface.

2. The ultrasound sensor case according to claim 1, wherein,
at least one of the non-penetrating inner wall groove and/or the non-penetrating outer wall groove is discontinuously disposed.

3. The ultrasound sensor case according to claim 1, wherein,
the non-penetrating inner wall groove is positioned closer to the bottom portion than the non-penetrating outer wall groove is.

4. The ultrasound sensor case according to claim 1, wherein,
assuming that a distance from an inner bottom surface to an end surface of the ultrasound sensor case is 100%, the non-penetrating inner wall groove is positioned on the inner wall surface at a distance of 20% or less.

5. The ultrasound sensor case according to claim 1, wherein,
the side wall comprises a thick wall portion and a thin wall portion that is thinner than the thick wall portion.

6. The ultrasound sensor case according to claim 5, wherein,
the inner wall surface of the thick wall portion has a narrowed portion.

7. The ultrasound sensor case according to claim 5, wherein,
the non-penetrating inner wall groove is provided on the inner wall surface of the thin wall portion.

8. The ultrasound sensor case according to claim 1, wherein,
at least one of the non-penetrating inner wall groove and/or the non-penetrating outer wall groove has a width that changes along a depth direction.

9. The ultrasound sensor case according to claim 1, wherein,
at least one of the non-penetrating inner wall groove and/or the non-penetrating outer wall groove has an uneven depth.

10. The ultrasound sensor case according to claim 1, wherein,
at least one of the non-penetrating inner wall groove and/or the non-penetrating outer wall groove has an uneven width along a longitudinal direction.

11. The ultrasound sensor case according to claim 1, wherein,
at least one of the non-penetrating inner wall groove and/or the non-penetrating outer wall groove is inclined with respect to the bottom portion or is parallel to the bottom portion at least partially.

12. The ultrasound sensor case according to claim 1, wherein,
at least one of the non-penetrating inner wall groove and/or the non-penetrating outer wall groove has a curved shape at least partially.

13. The ultrasound sensor case according to claim 1, wherein,
at least one of the non-penetrating inner wall groove and/or the non-penetrating outer wall groove has a zigzag shape at least partially.

14. The ultrasound sensor case according to claim 1, wherein,
a plurality of the non-penetrating inner wall grooves and/or the non-penetrating outer wall grooves are provided.

15. The ultrasound sensor case according to claim 14, wherein,
the plurality of the non-penetrating inner wall grooves and the plurality of non-penetrating outer wall grooves are alternately disposed in a direction perpendicular to the bottom portion.

16. An ultrasound sensor apparatus comprising:
the ultrasound sensor case according to claim 1; and
a piezoelectric element disposed on the bottom portion of the ultrasound sensor case.
